(19) United States
(12) Patent Application Publication
(10) Pub. No.: US 2009/0017678 A1
(43) Pub. Date: Jan. 15, 2009

(54) Bent-Back Plug-Type Connector for Coaxial Cables

(75) Inventors: Sascha Meier, St. Gallen (CH); Marc Moser, Bartlett, IL (US)

Correspondence Address: THE WEBB LAW FIRM, P.C., 700 KOPPERS BUILDING, 436 SEVENTH AVENUE, PITTSBURGH, PA, 15219, US

(73) Assignee: HUBER+SUHNER AG, Herisau (CH)

(21) Appl. No.: 12/280,911

(22) PCT Filed: Jan. 30, 2007
(86) PCT No.: PCT/CH07/00046

§ 371 Date: Aug. 27, 2008

(30) Foreign Application Priority Data
Feb. 28, 2006 (CH) 0315/06

(51) Int. Cl. H01R 9/05

(52) U.S. Cl. 439/582

(57) ABSTRACT

A bent-back plug-type connector for coaxial cables includes a bent-back outer conductor having a first conductor section which extends along a plug axis and a second conductor section which adjoins the first conductor section and is arranged at an angle with respect thereto, as well as a first inner conductor, which is arranged concentrically and insulated in the first conductor section, and a second inner conductor, which is arranged concentrically and insulated in the second conductor section and is detachably connected to the first inner conductor in the corner region of the bent-back outer conductor. With such a plug-type connector, simpler fitting, a secure and permanent connection and simpler and more cost-effective production are achieved by virtue of the fact that the first inner conductor has a square cross section, and the fact that an opening is provided in the first inner conductor.

### TECHNICAL FIELD

The present invention relates to the field of plug-type connector technology for coaxial cables. Said invention relates to a bent-back plug-type connector for coaxial cables as per the preamble of claim 1.

### PRIOR ART

In the automotive industry, RF systems (GPS, external aerial for mobile radio, car radio etc.) are being increasingly integrated in the vehicles, and coaxial cables have to be laid and connected in the vehicle for these RF systems. Standards have been introduced in the USA and in Europe for such coaxial automotive plug-type connectors in order to make systems from different manufacturers compatible with one another. The existing standard in the USA is SAE/USCAR-18, and this corresponds to DIN standard 72594-1 (FAKRA) in Europe. The international standard is ISO-20860-1.

In this connection, the applicant already provides automobile plug-type connectors which are covered under the term ARC (Automotive Radiofrequency Connectors) and which have been developed as RF plug-type connector families specifically for telematics, multimedia, safety and security applications in automobiles and heavy goods vehicles.

This family includes angled plug-type connectors in which the coaxial cable to be connected is generally inserted into the plug-type connector such that it is bent-back through 90° with respect to the plugging direction or plug axis.

To date, the inner conductor in such bent-back plug-type connectors has been composed of two straight inner conductors which were plugged one into the other in a manner oriented perpendicular to one another during assembly of the plug-type connector. To this end, the first inner conductor which was oriented in the plugging direction and was formed as a solid rotary part was provided at the end with a fork into which a pin contact which is connected to the inner conductor of the coaxial cable was inserted perpendicular to the fork. Such angled plug-type connectors for the automotive sector are disclosed, for example, in DE-A1-10 2004 041 809 or DE-B3-103 39 965.

One disadvantage of the known designs is that the first inner conductor is not secured against twisting about its longitudinal axis or the plug axis. This can lead to a twisted first inner conductor first having to be straightened with a great deal of effort, so that the second conductor can be inserted into the fork. Furthermore, the fork is open at the rear, so that the second inner conductor can slip out of the fork at the rear given unfavorable circumstances. Finally, the pin contact of the second inner conductor in the fork is only jammed into the fork but not latched in.

### DESCRIPTION OF THE INVENTION

The object of the invention is to improve a bent-back plug-type connector of the type described in the introduction such that the disadvantages of known solutions are avoided and that, in particular, a plug-type connector is produced which has a reliable and long-lasting connection that is easy to assemble, particularly in the region of the inner conductor, and which can be produced in a simple and cost-effective manner.

The object is achieved by all the features of claim 1. The essence of the invention is the use of a first inner conductor which has a square cross section, and the provision in the first inner conductor of an opening which is bounded on both sides in the plug axis and into which the second inner conductor can be inserted in a latching and contact-making manner by way of one end. On account of the square cross section, it is possible to prevent the first inner conductor from twisting in the plug axis without further outlay, so that the opening is always correctly oriented for insertion of the second inner conductor. Bounding the opening on both sides ensures that the second inner conductor cannot slip out of the opening at the sides. Insertion in a latching manner provides additional security.

According to a preferred refinement of the invention, the first inner conductor is produced as a stamped and bent part from an elongate strip of a metal sheet and forms a tube which is concentric with respect to the plug axis, with, in particular, the first inner conductor having a cross section in the form of an equilateral triangle with three side walls, two of the side walls abutting in one corner of the triangle so as to form a butt joint, and the opening for inserting the second inner conductor at the rear end of the first inner conductor is in the form of a butt joint of extended width between the two side walls. The two side walls which abut at an angle of 60° and so as to form a butt joint form a slot-like opening in the region of the expanded butt joint, it being possible for the walls of said opening to be pressed elastically outward when a pin with a relatively large diameter is inserted, and to spring back again when the pin is withdrawn. According to one development, if, in particular, the second inner conductor is formed in the manner of a jack plug at that end by way of which it is inserted into the opening, the elastic behavior of the side walls creates a latching-in effect after the thickened pin is inserted. Production of the first inner conductor as a stamped and bent part has proven particularly cost-effective and simple.

Another refinement is characterized in that the first inner conductor has a cross section in the form of an equilateral triangle with three side walls, in that two of the side walls abut in one corner of the triangle so as to form a butt joint, and in that the opening for inserting the second inner conductor is arranged at the rear end of the first inner conductor between two fork arms of a contact fork which is formed there.

In the stamped and bent part, security against slipping out is provided by the opening being in the form of a slot and being bounded toward the rear end of the inner conductor by an integrally formed lug. This lug can be bent obliquely inward in order to facilitate insertion of the second inner conductor.

The first inner conductor can be prevented from twisting in a simple manner by the first inner conductor being held in a concentric manner in the first conductor section of the outer conductor by means of a substantially cylindrical dielectric, by the dielectric having a central through-opening for accommodating the first inner conductor, and by the cross section of the central through-opening corresponding to the square cross section of the first inner conductor.

That end of the second inner conductor which is averted from the first inner conductor is designed to accommodate the inner conductor of the coaxial cable to be connected.

The dielectric has an opening, in particular a slot, through which the second inner conductor can be inserted into the internal first inner conductor from the side, in the region of the opening in the first inner conductor.

The outer conductor is preferably bent back through an angle of approximately 90°.

On account of the design as a stamped and bent part, it is particularly easy to create a situation where, at the front end of the first inner conductor, the side walls in each case turn into individual contact tongues which together form a bushing for accommodating a plug pin which is provided on a mating piece for the plug-type connector, which bushing can be widened such that it can spring back.

The two conductor sections of the outer conductor are preferably hollow-cylindrical, and the outer conductor is integrally produced from a metal sheet as a stamped and bent part. As a result, production can be simplified further and be more cost-effective.

Contact tongues for making contact with a mating piece of the plug-type connector are then arranged in the first conductor section of the outer conductor. Latching tongues for latching into an insertable transition piece for the outer conductor of the coaxial cable are arranged in the second conductor section of the outer conductor.

The first conductor section of the outer conductor is preferably in the form of a hollow cylinder which is closed over the circumference, a plastic housing is snapped onto the first conductor section of the outer conductor, and latching tongues for latching into the plastic housing are provided on the first conductor section, latching points are formed on the first conductor section in order to connect the plastic housing and the outer conductor in a rotationally fixed manner, the plastic housing and the latching points are formed and arranged such that the plastic housing can be latched in graduated rotation positions, in particular in steps of 45°. On account of the closed design of the outer conductor in its front, first conductor section, the outer conductor can be used there as a guide for the plastic housing and wobbling play between the outer conductor and the plastic housing can thus be prevented in a simple and reliable manner.

In particular, the plug-type connector comprising the plastic housing, the outer conductor and the first inner conductor is compatible with the interface standards SAE/USCAR-18 and FAKRA (DIN 72594-1).

### BRIEF EXPLANATION OF THE FIGURES

The invention will be explained in greater detail below with reference to exemplary embodiments in conjunction with the drawing, in which

FIGS. 1-4 show a preferred exemplary embodiment of a bent-back plug-type connector according to the invention in the assembled state in various views, with FIGS. 1 and 3 showing the plug-type connector with a sectioned outer conductor, FIG. 2 showing a perspective side view of the plug-type connector, and FIG. 4 showing the plug-type connector in a view from the front, as seen in the direction of the plug axis;

FIGS. 5-8 show analogous views of the plug-type connector as per FIGS. 1-4 in the as yet unassembled state;

FIG. 9 shows various partial figures of various views of the first inner conductor from the exemplary embodiment of FIGS. 1-4;

FIG. 10 shows various partial figures of various views of the outer conductor from the exemplary embodiment as per FIGS. 1-4;

FIG. 11 shows an enlarged illustration of a detail from FIG. 5 with a second inner conductor inserted,

FIG. 12 shows two partial figures of various views of the dielectric from the exemplary embodiment as per FIGS. 1-4;

FIG. 13 shows various partial figures of various views of the first inner conductor according to another exemplary embodiment with a contact fork for accommodating the second inner conductor; and

FIG. 14 shows two partial figures of the longitudinal section through and a perspective side view of the second inner conductor from FIG. 2.

### WAYS OF IMPLEMENTING THE INVENTION

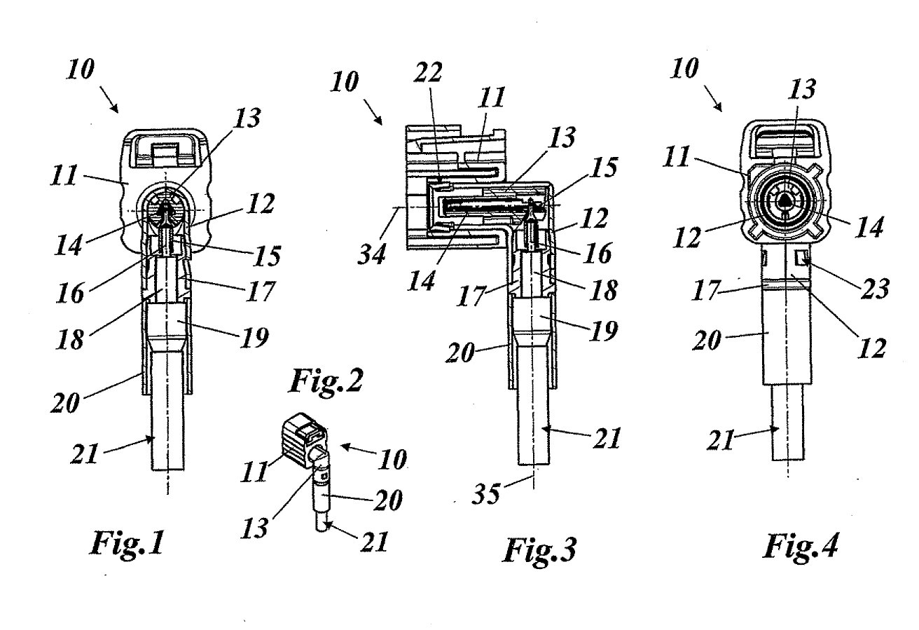

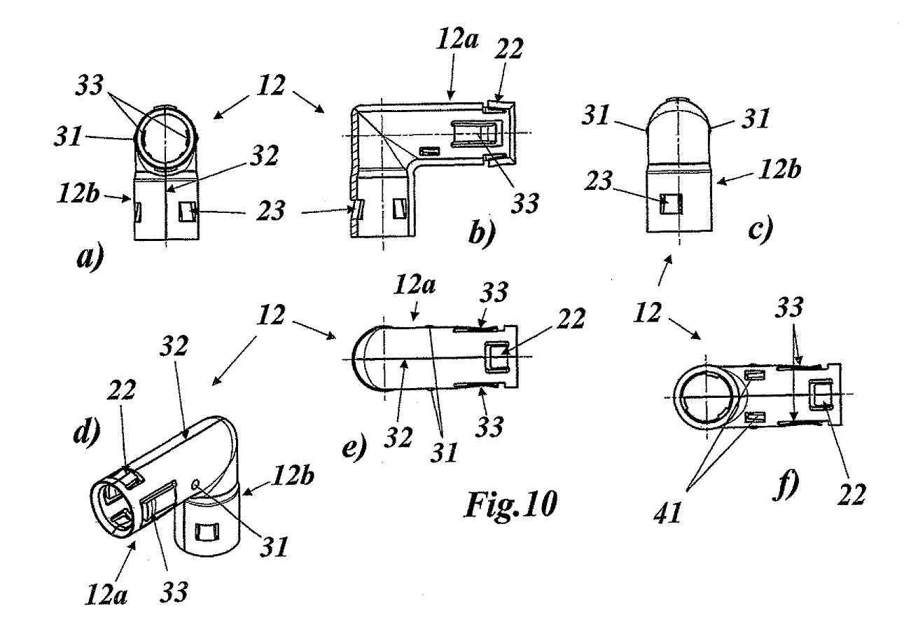

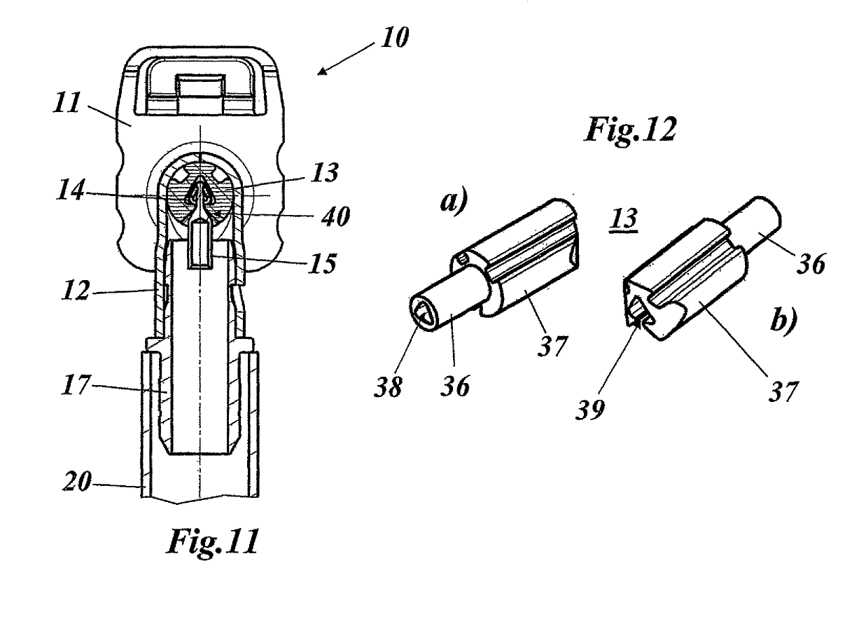

FIGS. 1-14 show various views and assembly states of exemplary embodiments of the plug-type connector according to the invention and its components. The bent-back plug-type connector 10 comprises a bent-back outer conductor 12 (see FIG. 10), two inner conductors 14 and 15 which are arranged in a concentric manner inside the outer conductor (also see FIG. 14), a standardized plastic housing 11, a transition piece 17 and a press sleeve 20. The first inner conductor 14 is mounted in an insulated manner in the front conductor section 12a of the outer conductor 12 by means of a cylindrical dielectric 13 (see FIG. 12). The hollow-cylindrical, electrically conductive transition piece 17 forms a plug connection with the end in the rear conductor section 12b of the outer conductor and is there latched by means of latching tongues 23 which latch into corresponding recesses on the outer face of the transition piece 17 (FIG. 11). The outer conductor 19 of the coaxial cable 21 (for example a braided shield) which is to be connected is pushed over the other end of the transition piece 17 and pressed by means of the surrounding press sleeve 20.

The outer conductor 12 which is illustrated in detail in FIG. 10 is in the form of an integral stamped and bent part and has corresponding butt joints 32. The outer conductor 12 comprises two tubular conductor sections 12a and 12b which adjoin one another and are at a right angle to one another. Two latching tongues 22 are formed opposite one another at the top and bottom on the first conductor section 12a, it being possible for the plastic housing 11 to be latched to the conductor section 12a, after being pushed onto it, by means of said latching tongues (see, for example, FIG. 3). Two contact tongues 33 which ensure electrical contact between the outer conductor 12 and the corresponding outer conductor of the mating piece when the plug-type connector 10 is inserted into a mating piece are arranged on the side of the first conductor section 12a. Furthermore, latching points 31 which serve to orient and guide the plastic housing 11 which is pushed onto the outer conductor 12 are formed on the sides behind the contact tongues 33 by embossing. The design of the outer conductor 12 as a hollow cylinder which is closed over the circumference ensures that the plastic housing 11 is guided on the outer conductor and undesirable wobbling play between the outer conductor 12 and the plastic housing 11 is reliably avoided. The plastic housing 11 is preferably formed such that it can be positioned in various rotation positions, which are each rotated through 45°, relative to the outer conductor in interaction with the latching points 31, Other latching steps of 30°, 60° or 90° are likewise possible.

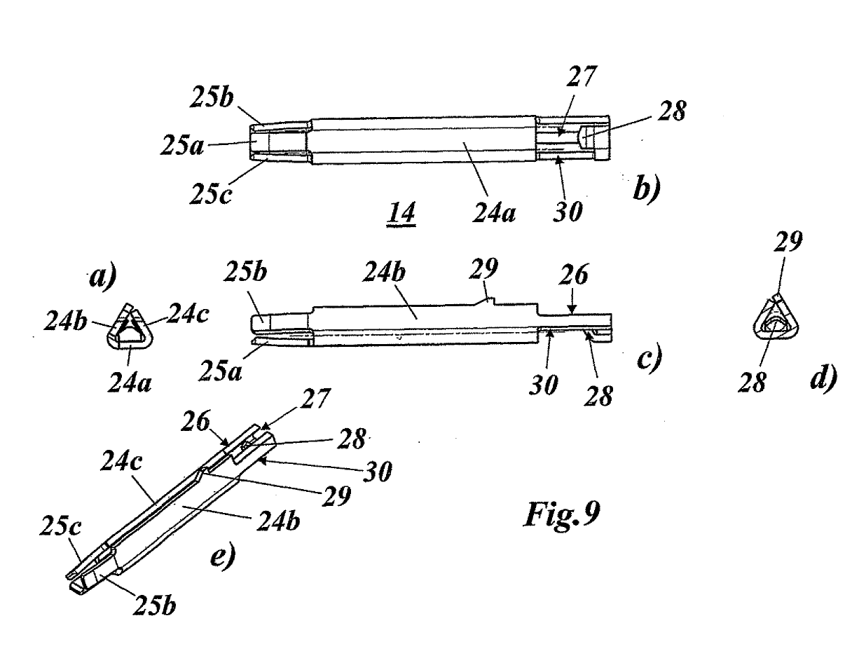

The first inner conductor 14 according to FIG. 9 is designed as an integral stamped and bent part. Its cross section is an equilateral triangle (FIGS. 9a and d) and has the side walls 24a, 24b and 24c which at the front end in each case become individual contact tongues 25a, 25b and 25c which can be elastically bent in the radial direction. The arrangement of the contact tongues 25a, 25b and 25c in a triangle forms a bushing into which a plug pin 10 which is present on the mating piece of the plug-type connector can be inserted in a contact-making manner. A slot-like opening 27, into which the second inner conductor 15 can be inserted in a latching manner by way of its front part which is formed in the manner of a jack plug (see FIGS. 11, 14), is formed between the top abutting side walls 24b and 24c at the rear end of the first inner conductor 14. The opening 27 is formed by the side walls 24b and 24c being provided with a recess 26 at the upper edge. A further recess 30 in the third side wall 24a ensures that the opening 27 is accessible from below. A lug 28, which is bent obliquely inward and blocks the opening 27 toward the end, is formed at the rear end of the recess 30. This ensures that the second inner conductor 15 which is inserted in the opening 27 cannot slip out of the opening 27 at the rear. At the same time, the inclined position of the lug 28 facilitates insertion of the second inner conductor 15 into the opening 27 from below.

The second inner conductor 14 is shown in detail in FIG. 14. Along its longitudinal axis, said second inner conductor comprises a sleeve part 46 with an axial bore 48 for accommodating the inner conductor of the coaxial cable and adjoining this a plug part 47 in the form of a jack plug which, at the front end, has a conically tapering tip 49 and a circumferential latching groove 50 formed behind it.

The first inner conductor 14 is held in a rotationally fixed manner in a central through-bore 38 in the dielectric 13 (FIG. 12), said through-bore having a corresponding triangular cross section. The dielectric 13 is divided into a first cylindrical section 36 with a relatively small outside diameter and a second cylindrical section 37 with a relatively large diameter. In this case, the outside diameter of the second section 37 is selected such that it matches the inside diameter of the first conductor section 12a of the outer conductor 12. The first section 36 accommodates the contact tongues 25a, 25b and 25c of the first inner conductor 14 and conforms to the plug-type connector standard. In the region of the opening 27 in the first inner conductor 14, the central through-opening 38 in the dielectric 13 is open toward the bottom by means of a slot 39, so that the second inner conductor 15 can be inserted into the opening 27 in the first inner conductor 14 through the slot 39 transverse to the plug axis 34. Bevels 40 on the walls of the slot 39 also facilitate insertion of the second inner conductor 15. The through-opening 38 in the dielectric 13 is designed to be larger in terms of cross-sectional area than the first inner conductor 14. A projection 29 which serves to guide and fix the first inner conductor 14 in the through-opening 38 is formed on the free upper edge of the side wall 24b of the first inner conductor 14.

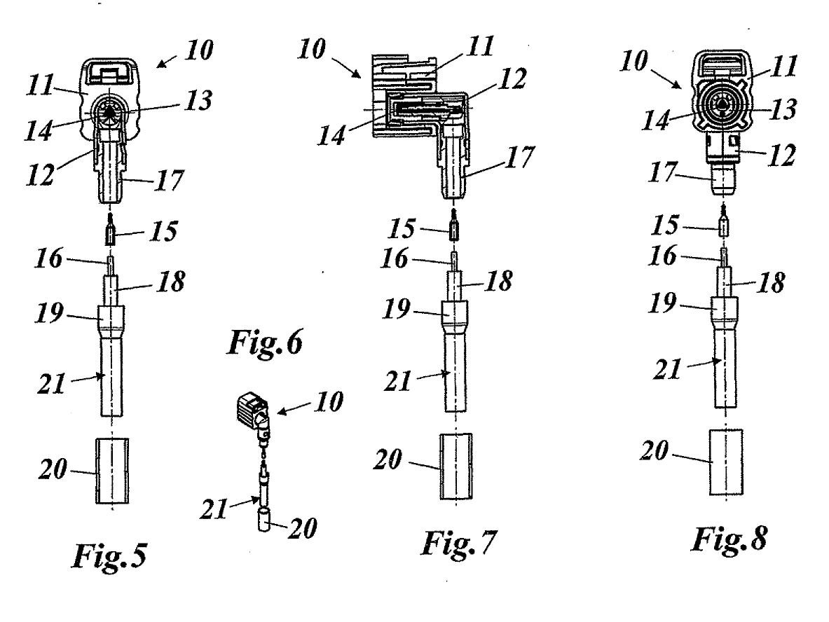

For assembly of the plug-type connector 10, the first inner conductor 14, together with the dielectric 13, is first inserted in a clamping manner into the first conductor section 12a of the outer conductor 12 (clamping tongues 41). Furthermore, the transition piece 17 is pushed into the second conductor section 12b in a latching manner. The coaxial cable 21 is prepared as per FIG. 5 and the second inner conductor 15, together with its sleeve-like section, is pushed over the exposed end of the inner conductor 16 of the coaxial cable 21 and fixed. The cable end with the second inner conductor 15 is then inserted into the second conductor section 12b through the transition piece 17, until the front end of the second inner conductor 15 latches in the opening 27 in the first inner conductor 14. At the same time, the outer conductor 19 of the coaxial cable 21 moves over the lower end of the transition piece 17 and can be fixed there in a contact-making manner by means of the press sleeve 20 pushed over it.

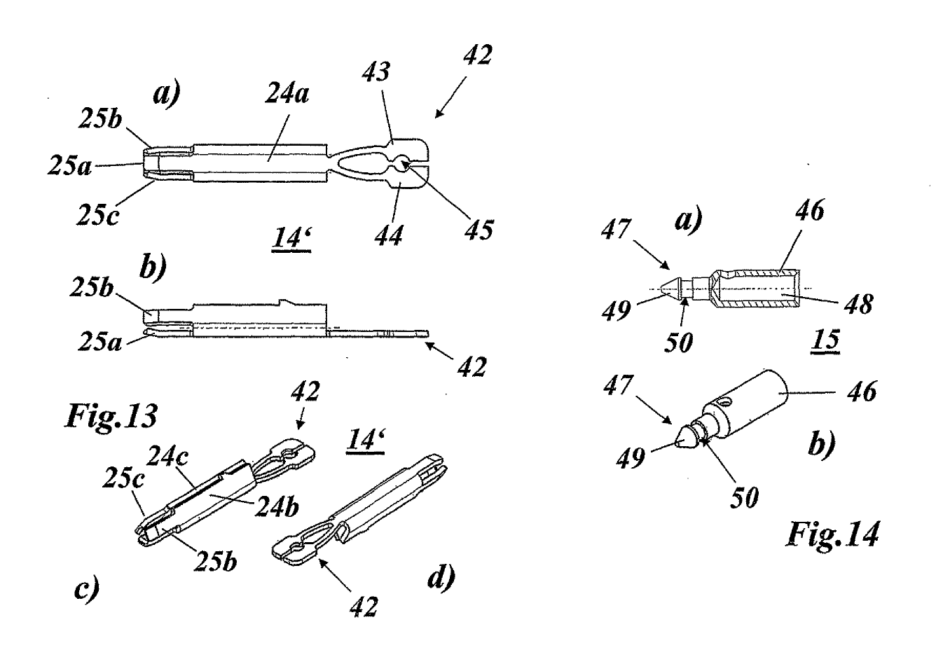

An embodiment of the first inner conductor, which embodiment represents an alternative to FIG. 9, is illustrated in FIG. 13. In the case of this first inner conductor 14′, the apparatus for connection to the second inner conductor 15 is in the form of a contact fork 42 between whose two fork arms 43 and 44 the opening 45 for accommodating the plug part 47 of the second inner conductor 15 is arranged. Reliable and mechanically stable contact between the two inner conductors 14′ and 15 is likewise achieved on account of this refinement of the first inner conductor 14′.

Overall, the plug-type connector according to the invention has the following properties and advantages:
the plastic housing 11 can be supported over the entire length of the outer conductor on account of the closed shape of the outer conductor 12 at the front, this resulting in a significant reduction in wobbling play (the outer conductor was previously slotted and pressed slightly inward at its front end, so that contact was made with the mating piece here);
contact with the outer conductor of the mating plug is ensured by the two slightly pressed-in lugs;
the outer conductor 12 can snap into the plastic housing 11 by way of the latching tongues (snap-action lugs) 22 at the front;
free rotation of the plastic housing 11 about the plug axis 34 is also possible on account of improved guidance between the plastic housing 11 and the outer conductor;
the lateral latching points 31 on the outer conductor 12 permit stepped, for example 45°, shifting of the rotation position of the plastic housing 11 around the plug axis 34;
the snap-action of the second inner conductor 15 which is configured in a mushroom-like manner and in the form of a jack plug, in the first inner conductor 14, 14′ is more reliably ensured;
in contrast to the round milled/twisted first inner conductor, the triangular first inner conductor 14, 14′ is already secured against twisting in the dielectric 13 or no longer has to be straightened before insertion of the second inner conductor 15; and
the snapped-in second inner conductor 15 is guided; it can no longer slip out at the rear.

### LIST OF REFERENCE SYMBOLS

10 Plug-type connector (bent-back)
11 Plastic housing
12 Outer conductor
12a, b Conductor section
13 Dielectric
14, 14′, 15 Inner conductor
16 Inner conductor (coaxial cable)
17 Transition piece
18 Dielectric (coaxial cable)
19 Outer conductor (coaxial cable)
20 Press sleeve
21 Coaxial cable
22, 23 Latching tongue
24a, b, c Side wall (inner conductor 14, 14′)
25a, b, c Contact tongue (inner conductor 14, 14′)
26, 30 Recess
27 Opening (slot-like)
28 Lug
29 Projection
31 Latching point
32 Butt joint
33 Contact tongue
34 Plug axis
35 Longitudinal axis (coaxial cable)
36, 37 Section (dielectric)
38 Through-opening
39 Slot
40 Bevel
41 Clamping tongue
42 Contact fork
43, 44 Fork arm
45 Opening
46 Sleeve part
47 Plug part
48 Bore
49 Tip (conical)
50 Latching groove (circumferential)

1-18. (canceled)

19. A bent-back plug-type connector for coaxial cables, comprising a bent-back outer conductor with a first conductor section which extends along a plug axis;
a second conductor section which adjoins the first conductor section and is arranged at an angle to the first conductor section;
a first inner conductor which is arranged in a concentric and insulated manner in the first conductor section; and
a second inner conductor which is arranged in a concentric and insulated manner in the second conductor section and is detachably connected to the first inner conductor in a corner region of the bent-back outer conductor,
wherein the first inner conductor has a square cross section, and wherein an opening, which is bounded on both sides by the plug axis and into which the second inner conductor can be inserted in a latching and contact-making manner by way of one end, is provided in the first inner conductor.

20. The plug-type connector as claimed in claim 19, wherein the first inner conductor is produced as a stamped and bent part from an elongate strip of a metal sheet and forms a tube which is concentric with respect to the plug axis.

21. The plug-type connector as claimed in claim 20, wherein the first inner conductor has a cross section formed as an equilateral triangle with three side walls, where two of the side walls abut in one corner of the triangle so as to form a butt joint, and where the opening for inserting the second inner conductor at a rear end of the first inner conductor is formed as a butt joint of extended width between the two side walls.

22. The plug-type connector as claimed in claim 21, wherein the opening is formed as a slot and is bounded toward the rear end of the first inner conductor by an integrally formed lug, and the lug is bent obliquely inward in order to facilitate insertion of the second inner conductor.

23. The plug-type connector as claimed in claim 20, wherein the first inner conductor has a cross section formed as an equilateral triangle with three side walls, where two of the side walls abut in one corner of the triangle so as to form a butt joint, and where the opening for inserting the second inner conductor is arranged at a rear end of the first inner conductor between two fork arms of a contact fork formed at the rear end of the first inner conductor.

24. The plug-type connector as claimed in claim 19, wherein the first inner conductor is held in a concentric manner in the first conductor section of the outer conductor by means of a substantially cylindrical dielectric, the dielectric has a central through-opening for accommodating the first inner conductor, and a cross section of the central through-opening corresponds to the square cross section of the first inner conductor.

25. The plug-type connector as claimed in claim 21, wherein the second inner conductor is formed as a jack plug at an end thereof that is inserted into the opening.

26. The plug-type connector as claimed in claim 19, wherein an end of the second inner conductor which is averted from the first inner conductor is designed to accommodate an inner conductor of a coaxial cable to be connected.

27. The plug-type connector as claimed in claim 24, wherein the dielectric has an opening through which the second inner conductor is inserted into the first inner conductor from a side in a region of the opening in the first inner conductor.

28. The plug-type connector as claimed in claim 19, wherein the outer conductor is bent back through an angle of approximately 90°.

29. The plug-type connector as claimed in claim 21, wherein at a front end of the first inner conductor, the side walls in each case turn into individual contact tongues which together form a bushing for accommodating a plug pin, which bushing is adapted to be widened such that it springs back.

30. The plug-type connector as claimed in claim 19, wherein the first conductor section and the second conductor section of the outer conductor are hollow-cylindrical in shape, and the outer conductor is integrally produced from a metal sheet as a stamped and bent part.

31. The plug-type connector as claimed in claim 29, wherein contact tongues for making contact with a mating piece of the plug-type connector are arranged in the first conductor section of the outer conductor.

32. The plug-type connector as claimed in claim 30, wherein latching tongues for latching into an insertable transition piece for an outer conductor of a coaxial cable are arranged in the second conductor section of the outer conductor.

33. The plug-type connector as claimed in claim 30, wherein the first conductor section of the outer conductor is formed as a hollow cylinder which is closed over the circumference, a plastic housing is snapped onto the first conductor section of the outer conductor, and latching tongues for latching into the plastic housing are provided on the first conductor section.

34. The plug-type connector as claimed in claim 33, wherein latching points are formed on the first conductor section in order to connect the plastic housing and the outer conductor in a rotationally fixed manner.

35. The plug-type connector as claimed in claim 34, wherein the plastic housing and the latching points are formed and arranged such that the plastic housing is adapted to be latched in graduated rotation positions.

36. The plug-type connector as claimed in claim 33, wherein the plug-type connector comprising the plastic housing, the outer conductor and the first inner conductor is designed to be compatible with the interface standards SAE/USCAR-18 and FAKRA (DIN 72594-1).

37. The plug-type connector as claimed in claim 19, wherein the plug-type connector is configured for use in standardized plug-type connections in the automotive sector

38. The plug-type connector as claimed in claim 27, wherein the opening of the dielectric is configured as a slot.

39. The plug-type connector as claimed in claim 35, wherein the plastic housing is adapted to be latched in graduated rotation positions having steps of 30°, 45°, 60° or 90°.
